(19) United States
(12) Patent Application Publication
(10) Pub. No.: US 2012/0081285 A1
(43) Pub. Date: Apr. 5, 2012

(54) Mouse

(75) Inventor: Jack A. Atzmon, Englewood, NJ (US)

(73) Assignee: Ergowerx, LLC., Englewood, NJ (US)

(21) Appl. No.: 13/201,609

(22) PCT Filed: Mar. 16, 2010
(86) PCT No.: PCT/US10/27492

§ 371 Date: Dec. 14, 2011

Related U.S. Application Data
(60) Provisional application No. 61/160,624, filed on Mar. 16, 2009.

(51) Int. Cl. G06F 3/033

(52) U.S. Cl. 345/163; 345/157; 345/167

(57) ABSTRACT

A pointing device for a computer and a method of using the pointing device. The pointing device includes a base, a motion tracking device coupled to the base; and a body pivotably coupled to the base. The body pivots with respect to the base about at least one axis.

### BACKGROUND OF THE INVENTION

1. Field of the Invention

The present invention relates to computer input devices and specifically to an ergonomic mouse

2. Description of the Related Art

Using a mouse or other pointing device for extended periods of time is associated with developing a repetitive strain injury (RSI). In place of mice, other devices have been developed such as trackballs or joysticks. Other ergonomic devices such as curved or shaped mice exist. However, these devices do not eliminate the risks of RSI. Additionally, current input devices are generally static devices.

### SUMMARY OF THE INVENTION

A pointing device for a computer and a method of using the pointing device. The pointing device includes a base, a motion tracking device coupled to the base; and a body pivotably coupled to the base. The body pivots with respect to the base about at least one axis. The body is pivoted by use to conform to the position of a user's hand.

The mouse challenges other “fixed position” mice by utilizing a pivot base that adapts to your natural hand and wrist movements. The mouse conforms to the user's unique positions and moves with the hand and wrist during use. This type of movement increases blood flow in the user's hand and wrist, which prevents irritation to the tendons and reduces the chance of injury.

### BRIEF DESCRIPTION OF THE DRAWINGS

FIGS. 1A-1C depict a side view of a mouse according to a first embodiment of the invention;

FIGS. 2A-2B depict a front view of the mouse of FIG. 1;

FIGS. 3A-3D depict a mouse according to another embodiment of the invention;

FIGS. 4A-4B depict a user's hand using the mouse of FIGS. 3A-3D;

FIGS. 5A-5C depict various ball joints for use with the mice of FIGS. 1-4; and

FIG. 6 depicts a universal joint for use with the mice of FIGS. 1-4.

### DETAILED DESCRIPTION OF THE INVENTION

Disclosed is a pointing device preferably embodied as a robotic mouse configured act as an input device. In one embodiment, the mouse reduces the occurrence of RSI. In a preferred embodiment, the upper surface of the mouse changes its position relative to the lower surface of the mouse or the surface upon which the mouse is used. Further, the mouse is adapted for use by either right or left-handed users.

As a user uses the mouse, the orientation of the user's hand naturally changes. Prior art pointing devices do not vary in accordance with this change in orientation. The present mouse is configures such that as the user's hand varies its orientation, the mouse body pivots to mach such an orientation.

The mouse is preferably configured to rock, swivel or pivot with movement so the user's hand and wrist are not in a fixed position. This movement creates a comfortable and healthy mouse experience.

For lateral pivoting motion, left and right wrist rotations provide constant freedom to move, allowing the hand and wrist to find the most neutral hand position for all mouse postures during use. The pivot base not only provides a natural side-to-side motion, but also simultaneously moves forward and back so the user's wrist is never confined. This allows the user's palm to guide the mouse/cursor around a desktop while the user's fingers are relaxed to focus on clicking.

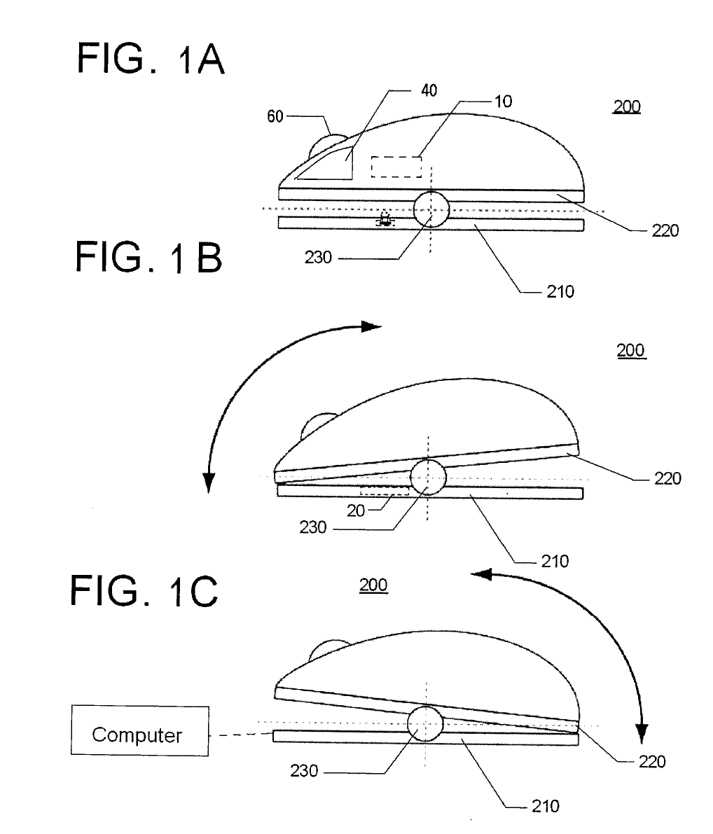

FIGS. 1A-1C depict a first embodiment of mouse 200. The mouse 200 includes right and left mouse buttons 50 and 40 respectively. Additionally, a third button, scroll wheel 60, or the like is included. The mouse 200 includes a position sensor 20 configured as a track ball, light sensor, laser, or the like to determine motion. Other mouse configurations include additional mouse buttons, fewer mouse buttons, additional scroll wheels, fewer scroll wheels, and the like.

In one embodiment, buttons 40, 50, and scroll wheel 60 are configured to move to vary the position of the user's hand. Buttons 40, 50 and/or scroll wheel 60 are adapted to move at least one of along the plane of the surface of the mouse body or raise and lower with respect to the surface of the mouse body. Preferably, a drive device 10 is coupled to the buttons 40, 50 and/or scroll wheel 60 to provide motion.

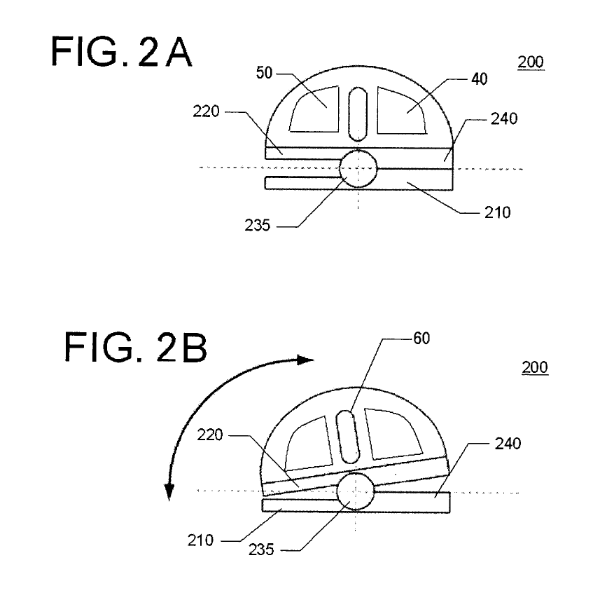

FIGS. 1A-1C depict a first embodiment of the ergonomic mouse 200. In this embodiment, a body 220 is coupled to a base 210 via a mount 230. The mount 230 can be a universal joint, pivot, hinge, axle, cam, track, track system, ball mount, or the like. As shown in side view FIG. 2b, the mouse housing 220 pivots about coupling joint 230 so that the front and back of the base 210 can substantially come in contact with base 210. It should be noted that in other embodiments, providing stops or bumpers to minimize the travel of body 220 could minimize motion.

In one embodiment, the stops are adjustable in height and/or position. Preferably, the stops are slideably mounted in tracks. The stops can be locked in place using screws that are accessible from a bottom side of the mouse or can be locked in place by a screw mechanism. A screw mechanism and slide for side-to-side adjustment is shown in dashed lines in FIG. 1A.

Further, housing 220 includes right and left mouse buttons as well as a scroll wheel or the like. Further, mouse 200 can track motion using a track ball, light sensor, LED, or the like. Other mouse configurations include additional or fewer mouse buttons, additional or fewer scroll wheels, and the like. The pivoting action shown in FIGS. 1A-1C is configured to substantially match a user's movement. In a preferred embodiment, the housing 220 has a rest position that is substantially parallel to the base 210. In another embodiment, the user sets the rest position to match the user's hand position. During use of a mouse, a user's hand naturally tilts at the wrist as the mouse is moved. The present mouse is configured to match the user's hand position during use. Preferably, movement of the mouse body to match the user's hand position does not vary a position of the cursor that the mouse controls.

FIGS. 2a and 2b depict the mouse of FIG. 1. The mouse can be adapted for a right-handed or left-handed user. The disclosed elements would be mirrored for a left-handed user. As shown, the housing 220 is coupled to base 210 through coupling joint 235. Coupling 235 may be the same as coupling joint 230. In another embodiment, there are separate coupling joints. Coupling joint 235 can be a hinge, an axle, a universal joint, a ball joint, cam, track, track system, or the like. The pivoting action shown in FIGS. 2A-2B can also be accomplished using a driving mechanism. The driving mechanism is coupled to a base of the mouse, the mouse body, and preferably, the buttons. It should be noted that in one embodiment, a gear mechanism, which can be embodied as a spring or a gear train, provides resistance to movement and maintains the mouse body in an equilibrium position.

As shown, an optional stop 240 prevents the mouse from pivoting beyond a certain point. Stop 240 is adapted to place the user's hand in an initial rest position. It should be noted that other mechanical stops, as discussed above could be used, as well as other motion limiting techniques. The mouse pivots to reduce the risks of RSI. It should be noted that stop 240 is preferably adjustable. Additionally, features from each of the embodiments can be combined with each other.

It should be noted that the mouse 200 preferably is configured to pivot both side-to-side and front-to-back. Additionally, circular motion is possible. In another embodiment, the pointing device is a track ball. In this embodiment, the base is configured to move so that a user's hand changes orientation to use the trackball in a manner similar to mouse 200.

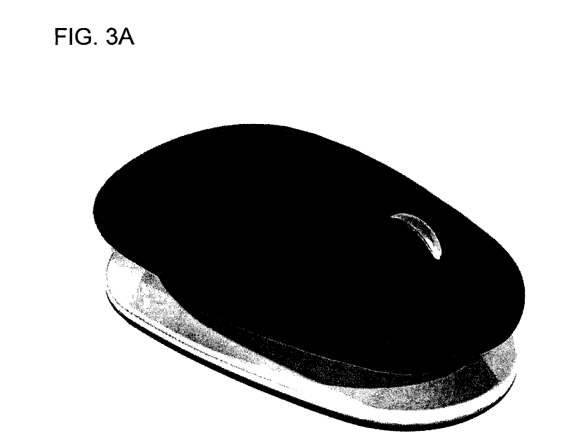

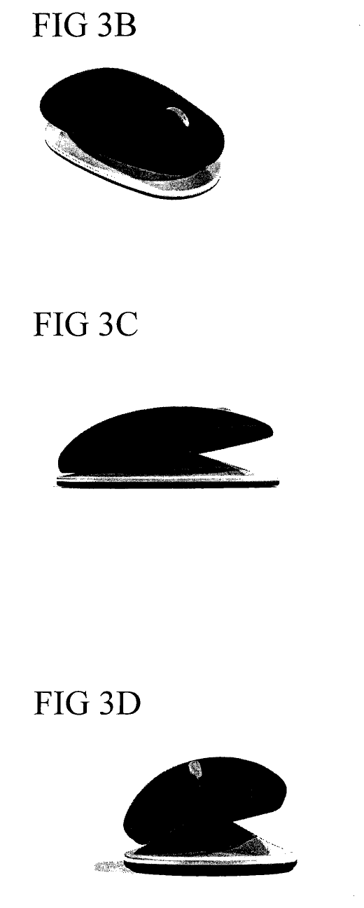

FIGS. 3A-3D depict another embodiment of the pointing device. As shown, the mouse has a single pivot point about which it changes position relative to the base. In one embodiment, electromagnets position the mouse body, in another embodiment, gears, or the like limit at least one of movement and speed of movement of the body with respect to the base. The pivot is preferably a ball and socket configuration.

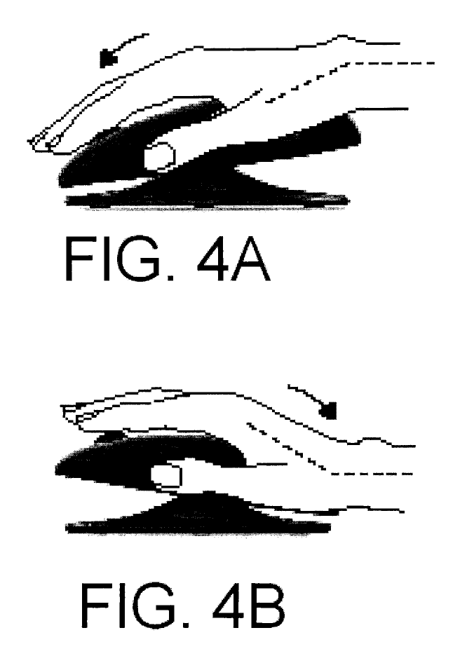

As shown in FIGS. 4A-4B, a user's hand to wrist orientation of varies with the pivoting of the mouse. As the user's hand undergoes a front to back pivot, the hand to wrist orientation undergoes a change as shown by a dashed line in FIGS. 4A and 4B. This change in position provides increased user comfort.

The mouse being configured to match the user's movements is aimed at relieving or preventing a specific disease such as carpal tunnel or other ailments due to repetitive motion. The movements of the mouse body eliminates repetitive motion from the same angle thereby improving blood flow, changing a position of the median nerve, and resting overworked muscles.

In one embodiment, the user can set the mouse or pointing device to a preferred position. The pointing device does not vary from that position or, alternatively, the user preset is the starting point for automatic motion.

Another embodiment could offer hand and wrist rest temperature changes in addition to the other mentioned adaptations to alleviate common hand and wrist and arm ailments. To that end, the mouse can be heated to warm a user's hands.

In one embodiment, the mouse has a display window (not shown). In one embodiment, the display window is an LCD display. The display can include such items as the specific user, speed setting, motion type, and the like. In one embodiment, the display notifies the user of imminent motion.

The present mouse is freely moveable in three or more axes. In one embodiment, the mouse provides resistance to motion in one or more directions.

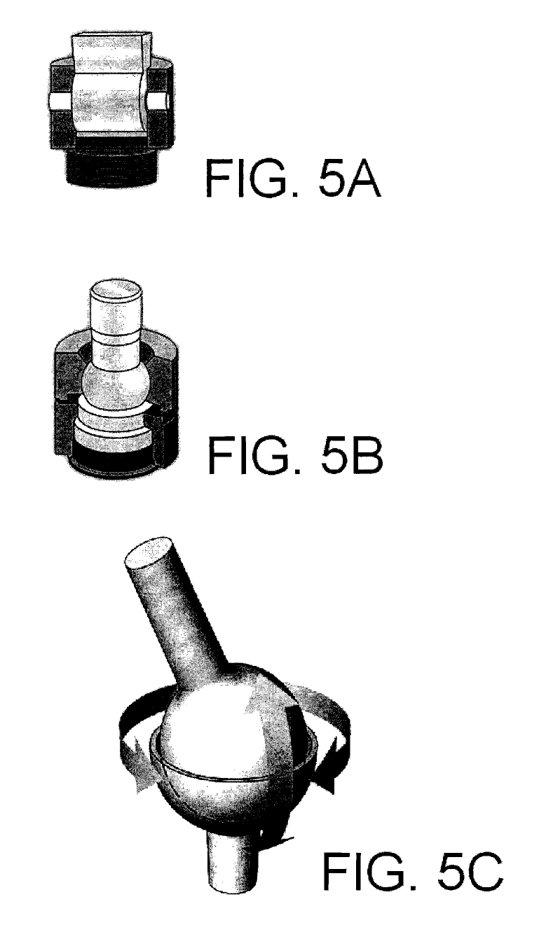

In one embodiment, the mouse is body and base are designed as a ball and socket configuration. The geometry is such that a “stem” with a “ball” is attached to the lower portion (or base) of the mouse. The ball will fit into a mating socket on the upper portion of the mouse. A retainer ring will then be screwed to the upper portion retaining the ball in its socket. The retaining ring and socket will be designed to create the desired drag (through friction) for the upper portion of the mouse to move separately from the base. It should be noted that the stem can also be attached to the upper portion. Various ball and socket assemblies are shown in FIGS. 5A-5C.

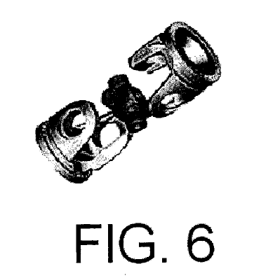

In one embodiment, the mouse configured using a universal joint concept. A universal joint is shown in FIG. 6. In this embodiment, the geometry consists of a “fork” attached to the top portion of the mouse. There is also another “fork” that is attached to the bottom portion of the mouse. This lower fork is about mounted 90 degrees from the upper fork (90 degrees on the “Y” axis, assuming the “y” axis is perpendicular to the work surface). Between the upper and lower fork parts, there is a connector part that has two perpendicular holes aligned on the same plane. Each fork is then screwed to the connector parts holes, which allows them to rotate independently on two separate axes at the same time. The desired drag of the universal joint is dictated by the slip fits designed into the yoke and connector parts.

In one embodiment, the mouse use either or both of the mechanisms described in above. However, in this concept the mouse itself is not intended to move on the work surface. When the upper portion of the mouse is rotated (as the base remains static), there are electrical switches that will be activated to create the motion of the pointer on the computer.

In one embodiment, the mouse is a cupped housing design. The geometry is such that the bottom portion of the mouse and the top portion of the mouse are split with a spherical radius. The spherical radius split creates the mating surfaces of the upper and the bottom portion of the mouse, to allow them to rotate separately around the center point of the spherical radius. Within the bottom portion of the mouse, there is a stem that protrudes up through the top portion of the mouse. After the top portion of the mouse is assembled (before the outer cover is assembled), there is a retaining part that connects to the lower stem and holds the two halves together. This retaining part will also provide the friction for the desired feel of the rotation. Once this is completed, the outer cover (or aesthetic part) can be assembled.

It should be noted that springs or other retention devices can pretension any of the previously described embodiments.

The mouse can be a standard PS2 mouse, a USB mouse, a Bluetooth mouse, or the like. In a preferred embodiment, the mouse base includes a storage area for a USB/Bluetooth dongle.

While this invention has been described by reference to a preferred embodiment, it should be understood that numerous changes could be made within the spirit and scope of the inventive concepts described. Accordingly, it is intended that the invention not be limited to the disclosed embodiment, but that it have the full scope permitted by the language of the following claims. Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A pointing device configured to control a device comprising:
a base;
a motion tracking device coupled to the base; and
a body pivotably coupled to the base;
wherein pivoting of the body with respect to the base provides no input data to control the device.

2. The pointing device according to claim 1, further comprising at least one button, wherein a drive causes the button to vary its position with respect to at least one of the body and the base.

3. The pointing device according to claim 2, wherein the body further comprises at least two buttons at a first end of the body and a second end of the body adapted to a palm of a user.

4. The pointing device according to claim 3, wherein each of the body portions is adapted to move independently.

5. The pointing device according to claim 4, wherein the body portions move in a synchronized manner.

6. The pointing device according to claim 1, wherein the device to which the pointing device is connected is a computer.

7. The pointing device according to claim 1, wherein the body further comprises at least two buttons at a first end of the body and a second end of the body adapted to a palm of a user.

8. The pointing device according to claim 7, wherein each of the body portions is adapted to move independently.

9. The pointing device according to claim 8, wherein the body portions move in a synchronized manner.

10. The pointing device according to claim 3, wherein the pointing device is a mouse.

11. The pointing device according to claim 3, wherein the pointing device is a trackball.

12. The pointing device according to claim 3, further comprising a stop to limit a side-to-side pivoting of the body with respect to the base.

13. The pointing device according to claim 1, wherein one of the base and the body comprises a ball assembly and the other of the base and the body comprises a stem assembly.

14. The pointing device according to claim 1, wherein a bias device maintains the body in an equilibrium position.

15. The pointing device according to claim 1, wherein the bias device is at least one spring.

16. A method of operating a pointing device, the pointing device comprising a base, a body pivotably coupled to the base, the body configured to pivot about at least one axis, the method comprising:
connecting the pointing device to a computer;
moving the pointing device to move a cursor position associated with the computer; and
tilting the pointing device body while moving the cursor, the tilting of the pointing device body having no affect on the cursor position.

17. The method according to claim 16, further comprising returning the body to an equilibrium position with a bias device.
